(19) United States
(12) Patent Application Publication
(10) Pub. No.: US 2026/0341993 A1
(43) Pub. Date: Oct. 29, 2026

(54) TERMINAL MATERIAL AND TERMINAL

(71) Applicant: Kabushiki Kaisha Kobe Seiko Sho (Kobe Steel, Ltd.), Kobe-shi (JP)

(72) Inventors: Masahiro TSURU, Shimonoseki-shi (JP); Shintaro YAMAMOTO, Kobe-shi (JP); Sho KATSURA, Kobe-shi (JP); Hirotaka ITO, Kobe-shi (JP); Takayuki KOYAMA, Kobe-shi (JP)

(73) Assignee: Kabushiki Kaisha Kobe Seiko Sho (Kobe Steel, Ltd.), Kobe-shi (JP)

(21) Appl. No.: 19/113,052

(22) PCT Filed: Sep. 4, 2023
(86) PCT No.: PCT/JP2023/032243

§ 371 Date: Mar. 19, 2025

(30) Foreign Application Priority Data
Sep. 22, 2022 (JP) 2022-151505

(51) Int. Cl. H01R 13/03; C25D 3/12; C25D 3/46; C25D 5/12; C25D 7/00; C25D 15/00

(52) U.S. Cl. CPC H01R 13/03; C25D 3/12; C25D 3/46; C25D 5/12; C25D 7/00; C25D 15/00; H01R 2201/26

(57) ABSTRACT

Disclosed is a terminal material includes, in this order: a base material composed of copper or a copper alloy; an underlayer composed of one or more layers, each formed from one or more selected from the group consisting of Ni, Co, and Fe; and a silver-containing film, wherein the silver-containing film includes a silver plating layer containing 50% by mass or more of silver and particles made of a non-conductive organic compound, each particle having a circle-equivalent diameter of 50 μm or less and being in contact with the silver plating layer, and a contact resistance of a silver-containing film-side surface of the terminal material is 1 mΩ or less when the following fretting wear test is performed: Fretting wear test: the terminal material as a test object and a mating material in which a hemispherical protrusion with a radius of curvature R=1.8 mm is formed for the silver-containing film-side surface of the terminal material are prepared, the surface of the mating material with the protrusion is caused to slide reciprocally against the silver-containing film-side surface of the terminal material as the test object under an applied perpendicular load of 3 N, with a sliding distance of 50 μm, and at a sliding speed of 100 μm/second, a single back-and-forth sliding movement being defined as one cycle, and the sliding movement being repeated 10,000 cycles.

### TECHNICAL FIELD

The present disclosure relates to a terminal material and a terminal.

### BACKGROUND ART

With the recent trend toward lighter automobiles, there is a growing need to reduce the amount of wire harnesses used in automobiles. For example, the amount of used wire harnesses can be reduced by directly connecting devices such as engines and motors to electronic components that control them (hereinafter referred to as “ECUs”).

Since devices such as engines and motors vibrate violently, connectors used for the connection and terminals that make up the connectors are exposed to severe vibration. Such vibration may cause fretting wear (i.e., a phenomenon in which fretting is repeated to cause wear of plating or the like at contacts) on the terminals. In recent years, the miniaturization of terminals has resulted in reduced contact pressure and deteriorated vibration conditions, further increasing the likelihood of the fretting wear.

As for fretting wear, Patent Document 1 discloses a technique in which a base material of a copper alloy has its surface roughened, and Ni plating, Cu plating, and Sn plating are performed thereon, followed by a reflow process, to expose a predetermined Cu—Sn layer at the surface of a Sn layer. While this technique reduces the occurrence of fretting wear, once the fretting wear occurs, it may easily lead to a risk of the exposure of the base material.

To improve the wear resistance, the application of an Ag plating film has also been considered. It has long been aimed at improving wear resistance of an Ag plating film by increasing the hardness thereof, and the following methods, for example, have been studied:
(1) an increase in hardness of an Ag plating film by crystal grain refinement; and
(2) an increase in hardness by alloying Ag with selenium (Se), antimony (Sb), etc.

However, neither of the methods (1) and (2) is sufficient to improve wear resistance. In addition, Se and Sb are toxic elements, and need to be handled carefully. There is also a problem that alloying with Se and Sb decreases electrical conductance.

Various improvements of wear resistance by ideas other than an increase in hardness of a plating film have also been studied. As disclosed in Non-patent Documents 1 and 2, the following method has been studied:
(3) improvement of wear resistance by co-deposition (dispersion plating) of carbon-based particles into an Ag plating film.

In this study, graphite, carbon black (CB), and carbon nanotubes (CNTs) have been mainly used. In fact, Non-patent Document 1 discloses that an Ag-graphite composite plating film obtained by suspending graphite particles in an Ag plating solution for a plating process can realize better wear resistance in comparison with not only an Ag plating film, but also a hard Ag—Sb alloy plating film.

### CONVENTIONAL ART DOCUMENTS

### Patent Document

Patent Document 1: JP 2014-208904 A

### Non-Patent Document

Non-Patent Document 1: Materia Japan, Vol. 58, No. 1 (2019), pp. 41-43
Non-Patent Document 2: Proceedings of the 81st Conference of The Surface Finishing Society of Japan, 27A-1

### DISCLOSURE OF THE INVENTION

### Problems to be Solved by the Invention

In the conventional art related to (3) above, as disclosed in Non-Patent Documents 1 and 2, when the carbon particle dispersion plating is applied to a terminal material and sliding (insertion and removal thereof) is repeated, carbon particles held in the plating film may fall off as the contact part wears. Since carbon-based particles have good electrical conductivity, when these particles fall off from the terminal surface and are piled up around the contact point, a short-circuit at the contact point may be caused. Furthermore, the prior art related to (3) above may not sufficiently suppress fretting wear.

The present disclosure has been made in view of these circumstances, and it is an object thereof to provide a terminal material and terminal that can sufficiently reduce a short-circuit at a contact point due to falling off of conductive particles, while having sufficient fretting wear resistance and electrical conductivity.

### Means for Solving the Problems

The present invention according to a first aspect provides a terminal material including, in this order: a base material composed of copper or a copper alloy; an underlayer composed of one or more layers, each formed from one or more selected from the group consisting of Ni, Co, and Fe; and a silver-containing film, wherein the silver-containing film includes a silver plating layer containing 50% by mass or more of silver and particles made of a non-conductive organic compound, each of the particles having a circle-equivalent diameter of 50 μm or less and being in contact with the silver plating layer, and a contact resistance of a silver-containing film-side surface of the terminal material is 1 mΩ or less when the following fretting wear test is performed:

Fretting wear test: the terminal material as a test object and a mating material in which a hemispherical protrusion with a radius of curvature R=1.8 mm is formed for the silver-containing film-side surface of the terminal material are prepared, a surface of the mating material with the protrusion is then caused to slide reciprocally against the silver-containing film-side surface of the terminal material in the test object under an applied perpendicular load of 3 N, with a sliding distance of 50 μm, and at a sliding speed of 100 μm/second, a single back-and-forth sliding movement being defined as one cycle, and the sliding movement being repeated 10,000 cycles.

The present invention according to a second aspect provides the terminal material according to the first aspect, wherein the silver plating layer contains 90% by mass or more of silver.

The present invention according to a third aspect provides the terminal material according to the first or second aspect, wherein the non-conductive organic compound includes a carbonyl group (—C(═O)—) and has no cyclic structure, in a unit molecular structure.

The present invention according to a fourth aspect provides a terminal using the terminal material according to any one of the first to third aspects.

### Effects of the Invention

According to the embodiments of the present invention, it is possible to provide a terminal material and terminal that sufficiently reduces a short-circuit at a contact point due to falling off of conductive particles, while having sufficient fretting wear resistance and electrical conductivity.

### BRIEF DESCRIPTION OF THE DRAWINGS

FIG. 1 is a schematic cross-sectional view of an example of a terminal material according to the embodiments of the present invention.

FIG. 2 is a schematic cross-sectional view of another example of the terminal material according to the embodiments of the present invention.

FIG. 3 is a schematic cross-sectional view of another example of the terminal material according to the embodiments of the present invention.

FIG. 4 shows the results of fretting wear resistance evaluation of a terminal material No. 1.

FIG. 5 shows the results of fretting wear resistance evaluation of a terminal material No. 2.

FIG. 6 shows the results of fretting wear resistance evaluation of a terminal material No. 3.

FIG. 7 shows the results of fretting wear resistance evaluation of a terminal material No. 4.

FIG. 8 shows the results of fretting wear resistance evaluation of a terminal material No. 5.

FIG. 9 shows the results of fretting wear resistance evaluation of a terminal material No. 6.

### MODE FOR CARRYING OUT THE IN INVENTION

The inventors of the present application have studied from various angles in order to realize a terminal material that can sufficiently reduce a short-circuit at a contact point due to falling off of conductive particles, while having sufficient fretting wear resistance and electrical conductivity. As a result, it has been found that sufficient fretting wear resistance and electrical conductivity can be achieved by forming the terminal material with a predetermined layer structure. This structure includes a silver-containing film containing a silver plating layer and particles made of a non-conductive organic compound, each particle having a circle-equivalent diameter of 50 μm or less and being in contact with (or supported by) the silver plating layer. This is thought to be, for example, because the fretting (and heat generated by this, etc.) causes part of the non-conductive organic compound to decompose, diffuse and migrate to the vicinity of the terminal material surface and/or it causes part of the non-conductive organic compound to react with the silver plating layer in the vicinity of the terminal material surface, thereby decreasing the friction coefficient in the vicinity of the terminal material surface, which enhances the fretting wear resistance. Decomposition products and reactants are small in quantity and are not considered to reduce the electrical conductivity of the terminal material. In addition, since the non-conductive organic compound is in contact with the silver plating layer in the form of particles rather than film form, the silver plating layer can be exposed at the surface of the terminal material, so that the initial electrical conductivity of the terminal material can still be maintained.

Therefore, it has been possible to realize the terminal material that the possibility of a short circuit at the contact point due to falling off of the conductive particles has been able to be reduced sufficiently, while having sufficient fretting wear in resistance and electrical conductivity.

The above mechanism does not limit the scope of the embodiments of the present invention.

Hereinafter, a detailed description will be given of each requirement specified by the embodiments of the present invention.

The terminal material according to the embodiments of the present invention includes, in this order: a base material composed of copper or a copper alloy; an underlayer composed of one or more layers, each formed from one or more selected from the group consisting of Ni, Co, and Fe; and a silver-containing film, wherein the silver-containing film includes a silver plating layer containing 50% by mass or more of silver and particles made of a non-conductive organic compound, each of the particle having a circle-equivalent diameter of 50 μm or less and being in contact with the silver plating layer, and a contact resistance of a silver-containing film-side surface of the terminal material is 1 mΩ or less when the following fretting wear test is performed:

Fretting wear test: The above-mentioned terminal material as a test object and a mating material in which a hemispherical protrusion with a radius of curvature R=1.8 mm is formed for the silver-containing film-side surface of the terminal material are prepared. A surface of the mating material with the protrusion is caused to slide reciprocally against the silver-containing film-side surface of the terminal material as the test object under an applied perpendicular load of 3 N, with a sliding distance of 50 μm, and at a sliding speed of 100 μm/second, a single back-and-forth sliding movement being defined as one cycle, and the sliding movement being repeated 10,000 cycles.

The above-mentioned terminal material can reduce a short-circuit at a contact point due to falling off of conductive particles, while having sufficient fretting wear resistance and electrical conductivity.

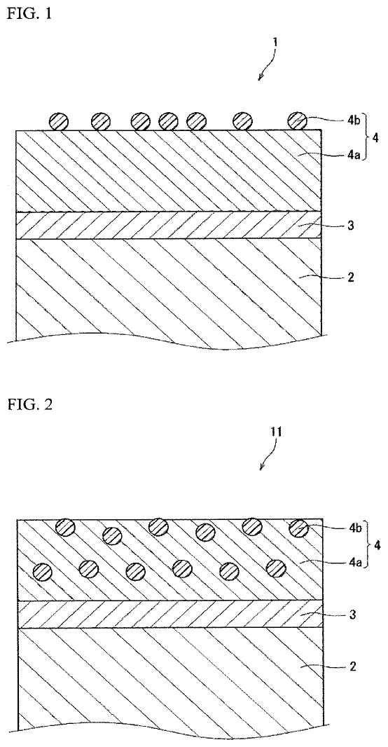

FIG. 1 is a schematic cross-sectional view of an example of the terminal material according to the embodiments of the present invention. In FIG. 1, a terminal material 1 includes, in this order: a base material 2 composed of copper or a copper alloy (hereinafter simply referred to as the “base material 2”); an underlayer 3 composed of one or more layers, each formed from one or more selected from the group consisting of Ni, Co, and Fe; and a silver-containing film 4, wherein the silver-containing film 4 includes a silver plating layer 4a and particles 4b made of a non-conductive organic compound (hereinafter simply referred to as the “particles 4b”), each particle having a circle-equivalent diameter of 50 μm or less and being in contact with (adhering to) the silver plating layer 4a. The terminal material 1 has a contact resistance of 1 mΩ or less at its silver-containing film 4 side surface when the above-mentioned fretting wear test is performed.

In addition to pure copper such as oxygen-free copper (OFC), one or more of copper alloys such as CuFeP-based, CuNiSi-based, CuTiCr-based, CuSnP-based, and CuMg-based alloys can be applied as the material for the base material 2. The properties required of terminal materials (electrical conductivity, springiness, strength, etc.) vary depending on where they are used. Because of this, the material for the base material 2 (and its tempering conditions) can be selected as appropriate according to the required properties.

The terminal material 1 including the base material 2 (and the terminal using the base material 2) can be used in a high temperature environment, for example, in an engine compartment of an internal combustion engine or in a battery connection part of an electric vehicle. In the high temperature environment, Cu in the base material 2 may diffuse toward the silver-containing film 4 and reach the surface of the silver-containing film 4, further forming a Cu oxide, which may lead to a risk of increasing the contact resistance of the terminal material 1.

Therefore, the underlayer 3 composed of one or more layers, each formed from one or more selected from the group consisting of Ni, Co, and Fe is provided between the base material 2 and the silver-containing film 4. This can suppress the diffusion of Cu from the base material 2 into the silver-containing film 4. In particular, the underlayer 3 preferably contains Ni from the viewpoint of plating workability or the like.

The underlayer 3 may be composed of a plurality of layers.

An average thickness of the underlayer 3 (for example, the average thickness of the underlayer 3 taken from any two or more cross sections of the terminal material) is preferably 0.1 μm or more, and more preferably 0.2 μm or more. This can suppress pinholes and the like and can effectively prevent the diffusion of copper. On the other hand, if the underlayer 3 becomes thicker, the effect of suppressing the diffusion of Cu can become saturated. From the viewpoint of productivity, cost, and workability during terminal forming, the average thickness of the underlayer 3 is preferably 3.0 μm or less, and more preferably 2.0 μm or less.

The silver plating layer 4a is a layer containing 50% by mass or more of silver. In addition to soft Ag plating, hard Ag plating, glossy Ag plating, semi-glossy Ag plating, and the like, which are used for ordinary terminal surface treatment, Ag alloy plating containing Sn and/or Ni, etc. can also be used for the silver plating layer 4a for the purpose of improving the corrosion resistance (sulfurization resistance, etc.) and fretting wear resistance of the silver-containing film 4. However, the fretting wear resistance may be imparted mainly by the particles 4b, which are essentially made of the non-conductive organic compound, and thus when there is no other purpose such as improving corrosion resistance, it is preferable to use a pure Ag plating layer with excellent electrical conductivity as a carrier. Thus, the silver plating layer 4a preferably contains 90% by mass or more of silver, more preferably 95% by mass or more, and even more preferably 99% by mass or more.

An average thickness of the silver plating layer 4a (e.g., the average thickness of the silver plating layer 4a, taken from any two or more cross sections of the terminal material), is not particularly limited and can be adjusted according to the application as appropriate, but it may be 100 μm or less, or even 50 μm or less, for example.

As for the particles 4b made of the non-conductive organic compound, the term “non-conductive” means that the organic compound does not exhibit electrical conductivity, and refers to, for example, particles exhibiting a volume resistivity of about 103 [Ω·cm] or more as measured in accordance with ASTM D257.

As for the particles 4b made of the non-conductive organic compound, the term “organic compound” refers to any carbon-containing compounds, excluding those with simple structures such as carbon monoxide, carbon dioxide, carbonates, hydrocyanic acid, cyanates, thiocyanates, B₄C and SiC. For example, silicone resins with a siloxane bond (—Si—O—Si—) as the main chain and an organic group in the side chain are included in the term “organic compound” as used herein.

The non-conductive organic compound preferably includes, within its unit molecular structure, one or more selected from the group consisting of a fluoro group (—F), a methyl group (—CH₃), a carbonyl group (—C(═O)—), an amino group (—NR¹R², where R¹ and R² are independently hydrogen or a hydrocarbon group, and R¹ and R² may be the same or different), and a hydroxy group (—OH). More preferably, the unit molecular structure contains a carbonyl group (—C(═O)—) and no cyclic structure. This can further enhance the fretting wear resistance.

Here, the term “unit molecular structure” means one repeating unit in the case of macromolecule (polymer) or an individual molecule in the case of a non-polymeric material.

As for the particle 4b made of the non-conductive organic compound, the term “particle” means a relatively small substance with a circle-equivalent diameter of 50 μm or less, and it may have any shape. In one embodiment of the present invention, from the viewpoint of electrical conductivity, the average particle size (average circle-equivalent diameter) of the particles 4b may be 10 μm or less. In one embodiment of the present invention, the average particle diameter of the particles 4b may be 0.1 μm or more from the viewpoint of fretting wear resistance.

FIG. 2 is a schematic cross-sectional view of another example of the terminal material according to the embodiments of the present invention. In the terminal material 11, the particles 4b are embedded in the silver plating layer 4a. The term “embedded” as used herein means that for each particle 4b, the entire particle 4b is fully embedded in the silver plating layer 4a, or a part of the particle 4b is embedded in the silver plating layer 4a with the remaining part exposed at the surface of the silver plating layer 4a.

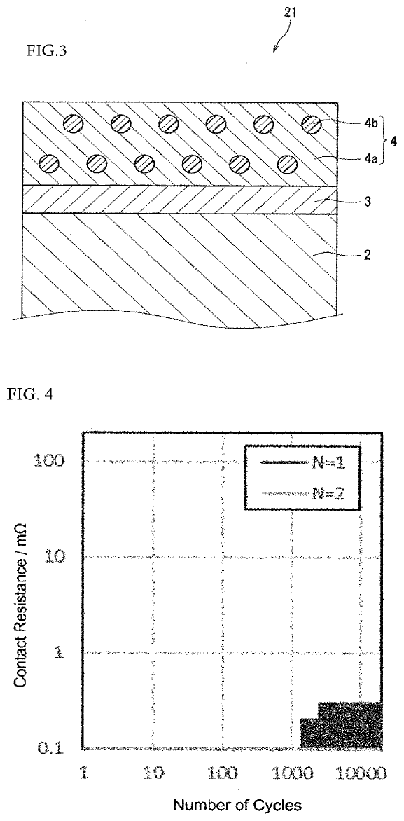

FIG. 3 is a schematic cross-sectional view of another example of the terminal material according to the embodiments of the present invention. In the terminal material 21, all the particles 4b are fully embedded in the silver plating layer 4a. In the case of FIG. 3, the particles 4b can be sized such that they are fully embedded in the silver plating layer 4a, which means that the average particle size of the particles 4b can be smaller than the thickness of the silver plating layer 4a.

In the terminal material according to the embodiments of the present invention, the term “particles are in contact” means that, for example, the particles 4b may be in contact with (adhere to) the surface of the silver plating layer 4a as shown in FIG. 1, or that the particles 4b may be co-deposited (embedded) in the silver plating layer 4a. In such a case, each particle 4b may be fully embedded in the silver plating layer 4a as shown in FIG. 3, or a part of each particle 4b may be exposed at the surface of the silver plating layer 4a as shown in FIG. 2. “Whether the particles are in contact” can be determined, for example, by observing the cross section of the terminal material 1 (11, 21).

From the viewpoint of further enhancing electrical conductivity (further reducing contact resistance), it is preferable that the particles 4b are co-deposited (embedded) in the silver plating layer 4a as shown in FIG. 2, or that all the particles are fully embedded in the silver plating layer 4a as shown in FIG. 3. Meanwhile, from the viewpoint of further enhancing the fretting wear resistance, it is preferable that the particles 4b are in contact with (adhere to) the surface of the silver plating layer 4a as shown in FIG. 1, or that the particles 4b are co-deposited (embedded) in the silver plating layer 4a as shown in FIG. 2.

In the terminal materials 1, 11 and 21 according to the embodiments of the present invention, conductive particles may be in contact with the silver plating layer 4a in some cases. However, the fewer the conductive particles, the more preferable it is because a short circuit at a contact point due to falling off of the conductive particles can be reduced. Thus, among the particles in contact with the terminal material 1, 11 and 21 according to the embodiments of the present invention, the proportion of the particles 4b made of the non-conductive organic compound is preferably 50% by volume or more, and more preferably 60% by volume or more, 70% by volume or more, 80% by volume or more, or 90% by volume or more. It is still more preferable that all (100% by volume) of the particles are the particles 4b made of the non-conductive organic compound. The terminal materials 1, 11 and 21 according to the embodiments of the present invention may also be in contact with inorganic particles in some cases.

The terminal materials 1, 11 and 21 according to the embodiments of the present invention may include other layers (e.g., a strike plating layer, etc.) so as to achieve the object of the present disclosure.

In a method for producing the terminal material 1 according to the embodiments of the present invention, for example, the underlayer 3 is first formed on the base material 2, such as a copper sheet, by passing an electric current through a predetermined plating solution that contains one or more selected from the group consisting of Ni, Co, and Fe, which are materials having the effect of suppressing the diffusion of copper, under general conditions. Thereafter, the silver plating layer 4a is formed by passing an electric current through a silver (or silver alloy) plating solution under general conditions. A dispersion solution of the particles 4b made of the non-conductive organic compound is then applied to the surface. Consequently, the terminal mater 1 is obtained. In some cases, a strike silver plating process may be applied before the silver plating process.

In the above-mentioned method, the particles 4b, which are made of the non-conductive organic compound, are dispersed in the silver (or silver alloy) plating solution and then subjected to electroplating while stirring, thereby producing the terminal material in which the particles 4b made of the non-conductive organic compound are co-deposited in the silver plating layer 4a (terminal material 11 with the particles 4b partially exposed at the surface of the silver plating layer 4a or terminal material 21 with the particles 4b fully embedded in the silver plating layer 4a).

During the process of co-depositing the particles 4b in the silver plating layer 4a by electroplating with the particles 4b dispersed in the plating solution, the following reactions (A) and (B) proceed simultaneously.
(A) Reaction in which the particles dispersed in the solution are electrostatically or physically adsorbed (contacted) to the surface of the base material
(B) Reaction in which the silver plating layer 4a is deposited (grown) on the surface of the base material.

The particles 4b adsorbed in the reaction (A) are incorporated into the silver plating layer 4a in the reaction (B), causing “co-deposition”. Under conditions where co-deposition plating progresses steadily, the adsorption of new particles 4b occurs while the initially adsorbed particles 4b are incorporated into the silver plating layer 4a. Thus, even when the plating process is stopped, the particles 4b are seen exposed at the topmost surface in many cases, whereby the terminal material 11 with parts of the particles 4b exposed at the surface of silver plating layer 4a can be easily manufactured in the normal co-deposition plating process.

Here, the amount of co-deposition of the particles 4b in the silver plating layer 4a is determined by the balance between an adsorption frequency of (A) and a plating film growth rate of (B). Thus, the amount of co-deposition can be adjusted by changing the plating conditions (and plating bath conditions). For example, at the end of the plating process, the processing is performed using a plating solution that does not contain the dispersed particles 4b therein, or alternatively an agitation speed of the plating solution is changed to decrease the adsorption frequency of (A). In this way, a layer where no particles 4b are co-deposited on the topmost surface side of the plating can be provided, thereby manufacturing the terminal material 21 where all particles 4b are fully embedded in the silver plating layer 4a.

The terminal materials 1, 11, and 21 according to the embodiments of the present invention have not only sufficient electrical conductivity but also sufficient fretting wear resistance. Specifically, the terminal materials 1, 11, and 21 according to the embodiments of the present invention can reduce the initial contact resistance to 1.0 mΩ or less, and can also reduce the contact resistance to 1.0 mΩ or less after 10,000 cycles of the following fretting wear test. It is preferable that the terminal materials 1, 11, and 21 according to the embodiments of the present invention can have a contact resistance of 1.0 mΩ or less even after 20,000 cycles of the following fretting wear test. <Fretting Wear Test> A terminal material as a test object and a mating material are prepared. In the mating material, a hemispherical protrusion with a radius of curvature R=1.8 mm is formed, for example, by hand pressing, for the silver-containing film-side surface of the terminal material. The surface of the mating material with the protrusion is caused to slide reciprocally against the silver-containing film-side surface of the terminal material as the test object under an applied perpendicular load of 3 N, with a sliding distance of 50 μm, and at a sliding speed of 100 μm/second, a single back-and-forth sliding movement being defined as one cycle. The sliding movement is repeated a predetermined number of cycles. A sliding tester, for example, CRS-B1050CHO manufactured by Yamazaki-Seiki co.jp, can be used.

A terminal according to the embodiments of the present invention includes the terminal material 1, 11, or 21 according to the embodiments of the present invention. The terminal according to the embodiments of the present invention can be manufactured by forming the terminal material 1, 11 or 21 according to the embodiments of the present invention into a terminal shape or by first forming the base material 2 into a terminal shape and then forming, on the base material 2, the underlayer 3 composed of one or more layers, each formed from one or more selected from the group consisting of Ni, Co and Fe, and the silver-containing film 4 (that contains the silver plating layer 4a and the particles 4b made of the non-conductive organic compound) and the like. The terminal according to the embodiments of the present invention can be used to connect devices such as engines and motors directly to an ECU.

### EXAMPLES

The embodiments of the present invention will be described in more detail by way of Examples. It is to be understood that the embodiments of the present invention are not limited to the following Examples, and various design variations made in accordance with the purports mentioned hereinbefore and hereinafter are also included in the scope of the embodiments of the present invention.

A pure copper material with a thickness of 0.3 mm (containing 99% by mass or more of copper) was used as the base material. After degreasing the surface of the base material by cleaning with acetone, an electric current was passed through the base material for 2 minutes at a current density of 5 A/dm² in a matte Ni watt bath, while using an Ni plate as a counter electrode, thereby forming an underlayer with a thickness of 1 μm (containing 99% by mass or more of Ni). Then, using a commercially available strike Ag plating solution (Dain Silver GPE-ST manufactured by Daiwa Fine Chemicals Co., Ltd.), an electric current was passed at a current density of 5 A/dm² for 1 minute to form a strike Ag plating layer (containing 99% by mass or more of silver) with a thickness of about 0.1 μm. Thereafter, using a commercially available non-cyanide based semi-glossy Ag plating solution (Dain Silver GPE-SB manufactured by Daiwa Fine Chemicals Co., Ltd.), particles made of each of various non-conductive organic compounds with a circle-equivalent diameter of 50 μm or less as listed in Table 1 and a surfactant (dispersing agent) were dispersed in respective predetermined amounts in the plating solution. While stirring the mixture, an electric current was passed for 5 minutes at a current density of 3 A/dm² by using a pure Ag plate as the counter electrode, thereby producing the terminal materials Nos. 1 to 4 containing a silver-containing film where each particle was co-deposited (embedded) in a semi-glossy Ag plating layer (containing 99% by mass or more of silver) with a thickness of about 10 μm. It is noted that as the surfactant of Nos. 1 to 3, Surflon S231 (manufactured by AGC Seimi Chemical Co., Ltd.) was used, and its amount added was set to 50 g/L. As for No. 4, sodium naphthalenesulfonate was used as the surfactant, and carboxymethyl cellulose (CMC) was used as the dispersing agent (stabilizer).

For comparison with the terminal materials of Nos. 1 to 4, terminal materials of Nos. 5 and 6, which did not contain particles made of a non-conductive organic compound, were fabricated. Unlike Nos. 1 to 4, in No. 5, a semi-glossy Ag plating layer (containing 99% by mass or more of silver) with a thickness of about 10 μm was formed without dispersing the particles made of various non-conductive organic compounds and the surfactant (dispersing agent) in the semi-glossy Ag plating solution. Unlike Nos. 1 to 4, in No. 6, a strike Ag plating layer (containing 99% by mass or more of silver) with a thickness of about 0.1 μm was formed using a strike Ag plating solution in a cyanide bath. Then, the semi-glossy Ag plating solution was changed to a glossy Ag plating solution (N-BRIGHT manufactured by Metalor Technologies). An electric current was passed for 15 minutes at a current density of 1.5 A/dm² by using a pure Ag plate as the counter electrode in the glossy Ag plating solution without dispersing the particles made of various non-conductive organic compounds and the surfactant (dispersing agent) in the glossy Ag plating solution, thereby forming a glossy Ag plating layer with a thickness of about 10 μm (containing 99% by mass or more of silver).

TABLE 1

| | Particles made of non-conductive organic compound | | | |
|---|---|---|---|---|
| | | | Addition | Average particle |
| No. | Particle type | Manufacturer, etc. | amount (g/L) | size (μm) |
| 1 | Polymethyl | Gantz Pearl GM-0105, | 70 | 2 |
| | methacrylate | manufactured by Gantz | | |
| | resin | Chemical Co., Ltd. | | |
| 2 | Nylon 12 | Nylon 12 powder, | 150 | 5 |
| | | manufactured by Toray | | |
| | | Industries, Inc. | | |
| 3 | Polyethylene | Polyethylene oxide powder, | 70 | 6 |
| | oxide | manufactured by Honeywell | | |
| | | International Inc. | | |
| 4 | Melamine | Melamine cyanurate | 30 | <2 |
| | cyanurate | dispersion, manufactured by | | |
| | | Nissan Chemical Corporation | | |
| 5 | — | — | — | — |
| 6 | — | — | — | — |

Initial contact resistance and fretting wear resistance were evaluated for the terminal materials of Nos. 1 to 6.

### <Evaluation of Initial Contact Resistance>

For each of the silver-containing film-side surfaces of the terminal materials of Nos. 1 to 6, the contact resistance was measured five times using an electric contact simulator (manufactured by Yamazaki-Seiki co.jp) under the conditions of a release voltage of 20 mV, a current of 10 mA, and a load of 3 N by a four-terminal method, and the average value of the measured contact resistances was used as an initial contact resistance value. The contact resistance exceeding 1.0 mΩ was considered to be a poor electrical conductivity (Poor), while the contact resistance of 1.0 mΩ or less was considered to be a sufficient electrical conductivity (Good).

### <Evaluation of Fretting Wear Resistance>

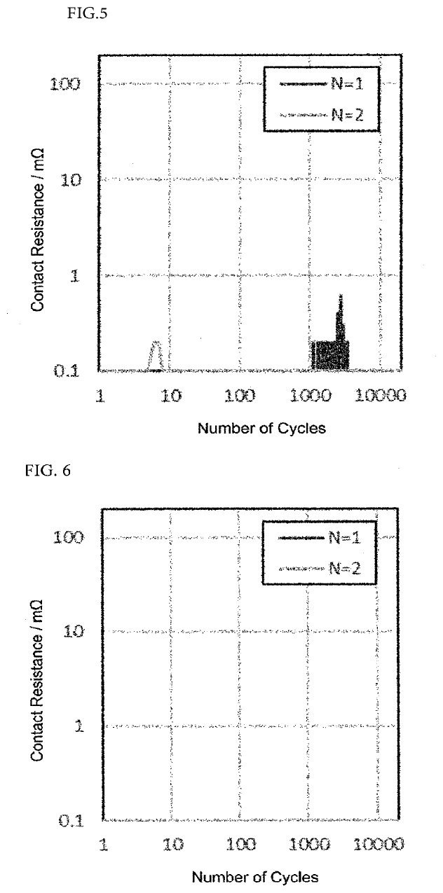

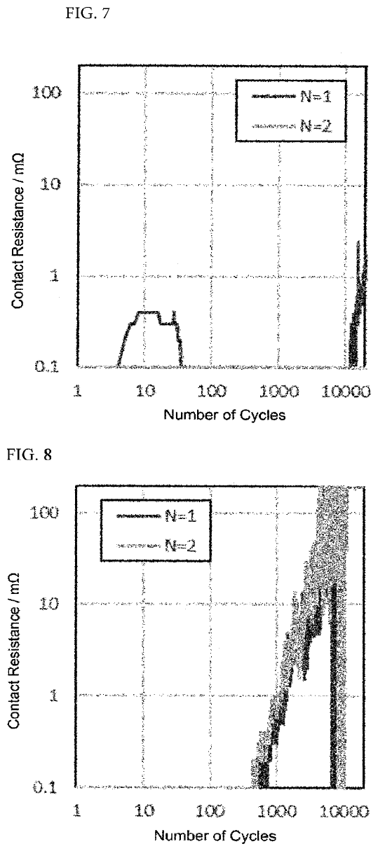

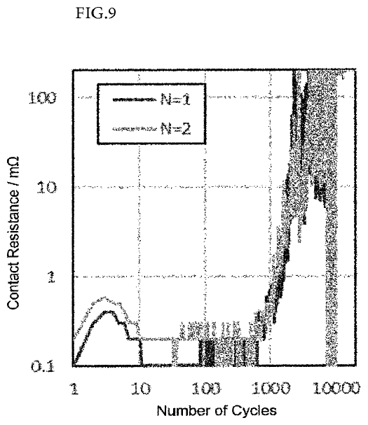

The terminal materials of Nos. 1 to 6 (with a size of 10 cm×10 cm) and mating materials (with a size of 0.5 cm×5 cm) are prepared. In the mating material, a hemispherical protrusion with a radius of curvature R=1.8 mm was formed by hand pressing, for the silver-containing film-side surface of the terminal material. The surface of the mating material with the protrusion was caused to slide reciprocally against the silver-containing film-side surface of the terminal material of each of Nos. 1 to 6 using CRS-B1050CHO, manufactured by Yamazaki-Seiki co.jp, as the sliding tester under an applied perpendicular load of 3 N, with a sliding distance of 50 μm, and at a sliding speed of 100 μm/second, a single back-and-forth sliding movement being defined as one cycle. The sliding movement was repeated a predetermined number of cycles, wherein the contact resistance after each cycle was measured by the same method as described above. The results are shown in FIGS. 4 to 9. FIGS. 4 to 9 each show the results of the fretting wear test performed on the terminal materials Nos. 1 to 6 with N=2.

As for the number of cycles at which the contact resistance exceeded 1.0 mΩ, the shorter number of cycles out of two tests, i.e., N=2, was used for evaluation. Terminal materials with the number of cycles of less than 10,000 were rated as being defective (Poor), those with the number of cycles from 10,000, inclusive, to less than 20,000 as sufficient (Good), and those with the number of cycles of 20,000 or more as excellent (Excellent). Furthermore, by checking a wear mark after 20,000 cycles, the presence or absence of exposure of the base material (or underlayer) was evaluated.

The above results are shown in Table 2. In a column of “Short-circuit prevention”, terminal materials in which 50% by volume or more of the particles in contact with the silver plating layer were non-conductive particles were determined that a short circuit at the contact point due to falling off of the particles can be sufficiently reduced (Good). Meanwhile, terminal materials in which less than 50% by volume of the particles in contact with the silver plating layer were non-conductive particles (that is, in which 50% by volume or more of the particles in contact with the silver plating layer were conductive particles) were determined that there is a possibility of a short circuit at the contact point due to falling off of the particles (Poor). In a column of “Overall judgment”, “Good” is described when the determination of “Good” is made in all the columns of “Short-circuit prevention”, “Electrical conductivity” and “Fretting wear resistance”. In addition, “Excellent” is described when the determination of “Excellent” is made in the column of “Fretting wear resistance”, and “Poor” is described when there is even one “Poor” determination in at least one of the columns of “Short-circuit prevention”, “Electrical conductivity” and “Fretting wear resistance”.

TABLE 2

| | | | Properties of terminal material | | | | | | |
|---|---|---|---|---|---|---|---|---|---|
| | Properties of particles | | | | | Fretting wear resistance | | | |
| | made of non- | | | | | | Presence | | |
| | conductive organic | | | | | | or | | |
| | compound | | | | | | absence | | |
| | | Inclusion | | | | Number | of | | |
| | | of | | | | of cycles | exposure | | |
| | | carbonyl | | Electrical conductivity | | with | of base | | |
| | | group and | | Initial | | contact | material | | |
| | | presence | Short- | contact | | resistance | after | | |
| | Particle | of cyclic | circuit | resistance | | exceeding | 20,000 | | Overall |
| No. | species | structure? | prevention | [mΩ] | Determination | 1 mΩ | cycles | Determination | determination |
| 1 | Polymethyl | Yes | Good | 0.27 | Good | >20,000 | Absence | Excellent | Excellent |
| | methacrylate | | | | | | | | |
| | resin | | | | | | | | |
| 2 | Nylon 12 | Yes | Good | 0.37 | Good | >20,000 | Absence | Excellent | Excellent |
| 3 | Polyethylene | Yes | Good | 0.37 | Good | >20,000 | Absence | Excellent | Excellent |
| | oxide | | | | | | | | |
| 4 | Melamine | No | Good | 0.20 | Good | 15,636 | Presence | Good | Good |
| | cyanurate | | | | | | | | |
| 5 | — | — | — | 0.21 | Good | 1,076 | Presence | Poor | Poor |
| 6 | — | — | — | 0.20 | Good | 1,178 | Presence | Poor | Poor |

From the results in Table 2, the following considerations can be made. The terminal materials Nos. 1 to 4 in Table 2 all satisfied the requirements specified by the embodiments of the present invention. They were able to sufficiently reduce a short circuit at the contact point due to falling off of the particles and had sufficient electrical conductivity and fretting wear resistance. Among them, the silver-containing films of Nos. 1 to 3 satisfied the preferred requirements that the non-conductive organic compound contained a carbonyl group (—C(═O)—) and had no cyclic structure, in the unit molecular structure, whereby the number of cycles at which the contact resistance exceeded 1.0 mΩ was 20,000 or more.

The terminal materials of Nos. 5 and 6 had a contact resistance exceeding 1.0 mΩ before the fretting wear test reached 10,000 cycles. This is considered to be because in the terminal materials of Nos. 5 and 6, the particles made of the non-conductive organic compound did not contact the silver plating layer, and the base material (or underlayer) was easily exposed due to the fretting wear, causing the base material and the like to be oxidized, resulting in an increased contact resistance. It is noted that the silver plating layer in No. 6 became harder than that in No. 5 due to the action of a gloss agent, and no significant improvement was observed, though the timing of the increase in contact resistance was slightly delayed.

This application claims priority based on Japanese Patent Application No. 2022-151505, filed on Sep. 22, 2022, the disclosure of which is incorporated by reference herein.

### EXPLANATION OF REFERENCES

1: Terminal material
2: Base material
3: Underlayer
4: Silver-containing film
4a: Silver plating layer
4b: Particle made of non-conductive organic compound
11: Terminal material
21: Terminal material

1. A terminal material, comprising, in this order:
a base material comprising copper or a copper alloy;
an underlayer comprising one or more layers, each formed from one or more selected from the group consisting of Ni, Co, and Fe; and
a silver-containing film, wherein
the silver-containing film comprises a silver plating layer comprising 50% by mass or more of silver and particles made of a non-conductive organic compound, each of the particles having a circle-equivalent diameter of 50 μm or less and being in contact with the silver plating layer, and
a contact resistance of a silver-containing film-side surface of the terminal material is 1 mΩ or less when the following fretting wear test is performed:
Fretting wear test: the terminal material as a test object and a mating material in which a hemispherical protrusion with a radius of curvature R=1.8 mm is formed on the silver-containing film-side surface of the terminal material are prepared, a surface of the mating material with the protrusion is then caused to slide reciprocally against the silver-containing film-side surface of the terminal material as the test object under an applied perpendicular load of 3 N, with a sliding distance of 50 μm, and at a sliding speed of 100 μm/second, a single back-and-forth sliding movement being defined as one cycle, and the sliding movement being repeated 10,000 cycles.

2. The terminal material according to claim 1, wherein the silver plating layer comprises 90% by mass or more of silver.

3. The terminal material according to claim 1, wherein the non-conductive organic compound includes a carbonyl group (—C(═O)—) and has no cyclic structure, in a unit molecular structure.

4. The terminal material according to claim 2, wherein the non-conductive organic compound includes a carbonyl group (—C(═O)—) and has no cyclic structure, in a unit molecular structure.

5. A terminal, comprising:
the terminal material according to claim 1.

6. A terminal, comprising:
the terminal material according to claim 2.

7. A terminal, comprising:
the terminal material according to claim 3.

8. A terminal, comprising:
the terminal material according to claim 4.
